(19) United States
(12) Patent Application Publication
(10) Pub. No.: US 2026/0346376 A1
(43) Pub. Date: Nov. 5, 2026

(54) LASER IRRADIATION DEVICE HAVING HYBRID PULSE SCANNER AND METHOD FOR PROCESSING MICROHOLES IN VACUUM PLATE BY USING SAME

(71) Applicant: 21 CENTURY CO., LTD., Hwaseong-si (KR)

(72) Inventors: Sung Hwan KIM, Suwon-si (KR); Soo Hyun PARK, Suwon-si (KR); Jung Min AHN, Yongin-si (KR)

(21) Appl. No.: 19/488,563

(22) PCT Filed: May 14, 2024
(86) PCT No.: PCT/KR2024/006536

§ 371 Date: Nov. 26, 2025

(30) Foreign Application Priority Data
Aug. 11, 2023 (KR) 10-2023-0105492

(51) Int. Cl. B23K 26/364; B23K 26/064; B23K 26/082

(52) U.S. Cl. CPC B23K 26/364; B23K 26/0648; B23K 26/082

(57) ABSTRACT

The laser irradiation device and the method thereof is provided, the laser irradiation device having a hybrid pulse scanner, which includes: a laser oscillator for emitting a femtosecond laser and a nanosecond laser; an optic portion for converting the path of a laser beam; and a hybrid pulse scanner for adjusting the size of the incident angle of a laser beam in real time by using (5+1) axes, and motion-controlling the adjusted irradiation angle of the laser beam in 5-axis directions, thereby processing microholes.

### TECHNICAL FIELD

The present invention relates to a laser irradiation device having a hybrid pulse scanner, and to a method of processing microholes in a vacuum plate by using the same, the vacuum plate being used when a thin-film sheet is conveyed or laminated by using a single laser irradiation device, in which super-microholes having improved roundness, cylindricity, and inner-surface roughness are processed in the vacuum plate.

### BACKGROUND ART

Generally, a vacuum plate is used for the purpose of adsorbing and conveying thin-film ceramic sheets, thin-film metal sheets, thin-film coating films, and the like, and sequentially laminating them onto an accurate location.

In the vacuum plate, super-microholes ranging from thousands to hundreds of thousands are formed, by which the thin-film sheet may be adsorbed, or the thin-film sheet may be released by a blower. This is applied to a laminating process for manufacturing laminated-type electronic components such as laminated ceramic capacitors, laminated ceramic varistors, and laminated ceramic actuators, as well as to a laminating process for manufacturing laminated-type batteries used in various electronic devices including electric vehicles, and other laminating processes.

When observing the process in which the thin-film sheet is laminated, the thin-film sheet first supplied from a winding roll is cut into a set size when it reaches a set location while moving along a conveyor.

Above the conveyor, a vacuum plate is installed to be movable along a rail, and the vacuum plate, in a state of contacting the surface of the cut thin-film sheet by descending, adsorbs the thin-film sheet through vacuum pressure, and moves the adsorbed thin-film sheet to a lower mold disposed at one side.

The vacuum plate descends while being located above the lower mold (laminated plate mold), and when the thin-film sheet becomes adjacent to the lower mold in this process, the vacuum pressure is released, thereby placing down the thin-film sheet onto the lower mold, so that the lamination is performed. This process is performed until the set number of thin-film sheets is reached.

In the vacuum plate, super-microholes ranging from thousands to hundreds of thousands are formed for adsorption and separation.

As a method of processing the microholes formed in the vacuum plate, a mechanical method by a drilling machine and a method using chemical etching may be used, but since both have poor surface roughness and large hole-diameter deviation, super-microholes within 150 μm are mostly processed using a laser.

As specific methods of processing microholes using a laser, single pulse boring methods, repetitive pulse boring methods, trepanning boring methods, helical boring methods, and the like are known, but the trepanning boring method is most widely used.

The trepanning boring method is a hole-processing method in which a laser beam is emitted to penetrate the center of a microhole to be processed, and then the lower stage is rotated by a desired hole diameter.

However, the laser-using processing methods described above have the following problems.

First, since the above laser processing is performed with a thermal process proceeding by melting of the material, melt protrusions and fragmental particles occur around the hole, and to remove these, a secondary grinding process such as electrolytic in-process dressing (ELID) should be performed. However, since the microholes are extremely small, even after the grinding process, nano-level fine particles remain on the rough surface inside the holes, and holes are clogged by repeated suction, or fine particles are discharged between the thin-film sheets being laminated, thereby causing a problem in that the thin-film sheet is pressed or torn.

Second, a post-process (deburring) through dedicated equipment separately provided should be undergone to remove burrs inside the processed microholes and simultaneously obtain a clear roughness of the inner surface.

Third, in the conventional laser method as described above, the incident angle (spot) of the emitted laser beam cannot be adjusted in real time, and since the laser beam is emitted only at an initially set incident angle, there is a limit to the irradiation angle of the beam relative to the incident angle of the laser beam, so that the aspect ratio of the microholes processed in the vacuum plate currently has a maximum value of 1:10. If the diameter of the laser beam is initially set smaller for processing, processing at an aspect ratio equal to or greater than 1:10 is possible, but conversely, there is a problem in that the quality of the inner surface of the processed hole cannot be secured.

### DISCLOSURE

### Technical Problem

The present invention has been devised to solve the problems and technical prejudices as described above, and has an object to provide a laser irradiation device having a hybrid pulse scanner and a method for processing microholes in a vacuum plate by using the same, which does not require a post-process using separate dedicated equipment for removing burrs existing around and on the inner surface of the microholes processed through single dedicated equipment for controlling in real time the incident angle (spot) of the emitted laser beam.

### Technical Solution

To achieve the aforementioned object, a laser irradiation device having a hybrid pulse scanner of the present invention comprises: a laser oscillator configured to simultaneously or selectively emitting a femtosecond laser beam and a nanosecond laser beam; an optic portion including a first reflection mirror and a second reflection mirror configured to convert a path of a laser beam incident from the laser oscillator; and a hybrid pulse scanner configured to adjust, in real time, the laser beam incident from the optic portion and a size of an incident angle of the laser beam by using (5+1) axes (X, Y, Xθ, Yθ, Z+Z-WD), while motion controlling an irradiation angle of the adjusted laser beam in 5-axis (X, Y, Xθ, Yθ, Z) directions, age a location where the microhole is to be processed, process a preliminary microhole at the aged location, bore the processed preliminary microhole, and deburr an inner surface of the bored microhole.

Here, the hybrid pulse scanner preferably comprises: an incident angle adjustment module configured to widen or narrow a working distance (WD) by adjusting the size of the incident angle of the incident laser beam as Z-Working Distance (Z-WD); a galvanometer scanner including, as five axes, a focusing module, the focusing module moving an incident angle location of the laser beam that has passed through the incident angle adjustment module in a Z-axis direction, an X-axis galvanometer, a Y-axis galvanometer, an Xθ-axis galvanometer, and a Yθ-axis galvanometer, which allow the laser beam passing through the focusing module to be selectively emitted in 2D or 3D shapes; a beam reflector configured to reflect the laser beam passed through the galvanometer scanner in the Z-axis direction; and a lens disposed below the beam reflector to focus an incident angle of the reflected laser beam onto the location where the microhole is processed.

At this time, it is preferable that the location where the microhole is to be processed is aged through emission of the nanosecond laser beam; at the aged location, while the femtosecond laser beam is selectively emitted in a 2D shape and in a 3D shape to process the preliminary microhole; and to the processed preliminary microhole, the microhole is bored while selectively emitting the nanosecond laser beam in a 2D shape and in a 3D shape together with controlling an irradiation angle of the nanosecond laser beam through (5+1)-axis motion control; and through the (5+1)-axis motion control, an inner surface of the processed microhole is deburred while emitting the nanosecond laser beam in a 3D shape along the inner surface of the processed microhole together with controlling the irradiation angle of the nanosecond laser beam.

Further, it is preferable that the femtosecond laser and the nanosecond laser emitted for processing the preliminary microhole and boring the microhole are respectively in a 2D-shaped spiral form and in a 3D-shaped helical form through X, Y motion combination control or X, Y, Z motion combination control among five axes of the hybrid pulse scanner.

Meanwhile, it is preferable that the incident angle adjustment module adjusts the size of the incident angle of the laser beam in real time through spacing adjustment of a pair of concave lenses; during processing of the preliminary microhole, a diameter of the femtosecond laser beam is widened to narrow the incident angle so that focused processing is performed by narrowing a working distance of the laser beam; and during boring of the microhole into the preliminary microhole, a diameter of the nanosecond laser beam is narrowed to widen the incident angle so that a melting pool method for melting a processing area is performed by widening the working distance of the laser beam.

A method for processing microholes in a vacuum plate, using a laser irradiation device, comprises: step S10 of aging by simultaneously or selectively emitting the nanosecond laser and the femtosecond laser to a location at which the microhole of the vacuum plate is to be processed; step S20 of processing the preliminary microhole while emitting the femtosecond laser beam in a 2D shape and in a 3D shape to the aged location; step S30 of boring the microhole while selectively emitting the nanosecond laser beam in a 2D shape and in a 3D shape together with controlling an irradiation angle of the nanosecond laser beam through (5+1)-axis (X, Y, Xθ, Yθ, Z+Z-WD) motion control to the processed preliminary microhole; and step S40 of deburring an inner surface of the microhole while emitting the nanosecond laser beam in a 3D shape along the inner surface of the microhole through the (5+1)-axis (X, Y, Xθ, Yθ, Z+Z-WD) motion control.

Further, in step S20, the emission of the femtosecond laser beam is preferably performed in a state in which the diameter of the beam is widened to narrow an incident angle so that focused processing is performed while a working

### Distance Is Narrowed.

At this time, in step S20, a pulse length of the femtosecond laser is preferably 100 fs to 10,000 fs (10 ps).

In addition, in step S30, it is preferable to narrow the diameter of the nanosecond laser beam so that the preliminary microhole is bored by a melting pool method of melting a processing area by widening a working distance of the incident angle while controlling the irradiation angle of the nanosecond laser beam.

In addition, in step S40, it is preferable to narrow the diameter of the nanosecond laser beam under control of the incident angle adjustment module, as a Z-WD axis, so as to widen an incident angle, and to control an irradiation angle of the beam such that only the widened incident angle is focused on an inner surface of the microhole, thereby deburring the inner surface of the microhole along the inner surface in a 3D-shaped helical form.

At this time, in step S30, a pulse length of the nanosecond laser is preferably 1 ns to 200 ns.

Lastly, in steps S20 and S30, it is preferable that the femtosecond laser and the nanosecond laser, which are emitted respectively, are repeatedly emitted in a 2D-shaped spiral form and in a 3D-shaped helical form, respectively, through X, Y motion combination control or X, Y, Z motion combination control among five axes of the hybrid pulse scanner.

### [advantageous Effects]

According to the laser irradiation device having a hybrid pulse scanner and the method for processing microholes in a vacuum plate by using the same of the present invention having the configuration as described above, since the femtosecond laser and the nanosecond laser are simultaneously or selectively emitted through single dedicated equipment, and the incident angle (spot) of the laser beam is allowed to be controlled in real time together with the 5-axis-direction motion control of the laser beam, the microhole may be processed deeper than an aspect ratio of 1:10, and since deburring is allowed to be performed immediately after the microhole boring, a microhole having guaranteed precise and high-quality roundness and cylindricity in the vacuum plate is processed, thereby providing an excellent effect of improving the quality of the vacuum plate.

In addition, since the femtosecond laser beam is emitted to process a preliminary microhole for processing the microhole, there is an effect that burrs are not formed around the hole.

In addition, since the processing part is aged in the single dedicated equipment, and the femtosecond laser beam and the nanosecond laser beam are sequentially and continuously emitted to form and bore the preliminary microhole, and immediate deburring of the bored inner surface is continuously performed, there is an effect not only that the processing time is shortened, but also that, above all, a separate post-process for burr removal and deburring, as in the conventional method, is not required.

### DESCRIPTION OF DRAWINGS

FIG. 1 is a diagram schematically illustrating a laser irradiation device according to the present invention,

FIG. 2 is a diagram illustrating a hybrid pulse scanner, which is one of the configurations of the laser irradiation device according to the present invention,

FIG. 3 is a diagram schematically illustrating a structure of the hybrid pulse Scanner,

FIG. 4 is a schematic diagram illustrating a process in which a microhole is bored by a laser beam.

FIG. 5 is a schematic diagram illustrating a process in which an inner surface of a bored microhole is deburred by the laser beam.

FIG. 6 is a process diagram illustrating a process in which a microhole is processed by using the laser irradiation device according to the present invention, and

FIG. 7 is a flowchart illustrating a process in which a microhole is processed.

### MODE FOR DISCLOSURE

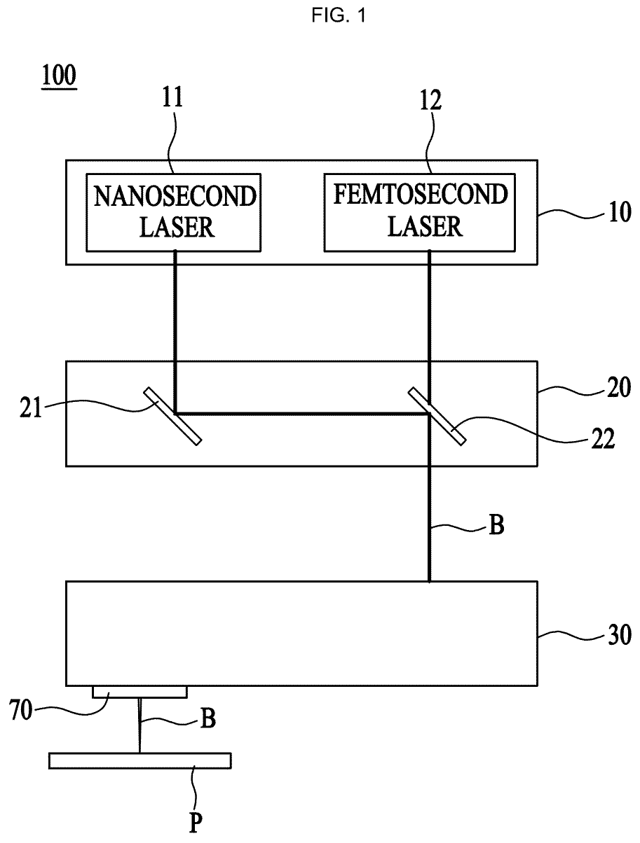

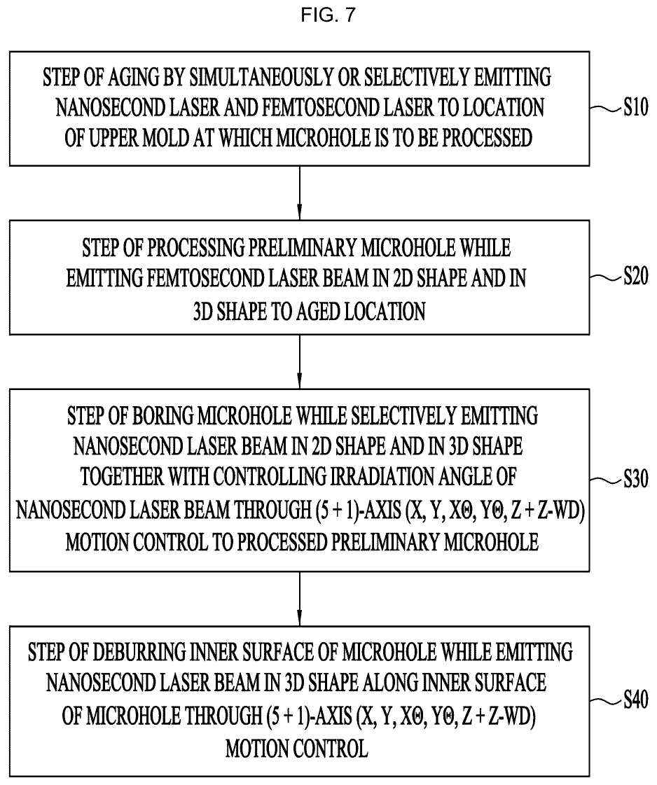

As illustrated in FIG. 1 to FIG. 7, a laser irradiation device 100 having a hybrid pulse scanner 30 of the present invention includes: a laser oscillator 10 for simultaneously or selectively emitting femtosecond laser 11 and nanosecond laser 12 beams; an optic portion 20 provided with a first reflection mirror 21 and a second reflection mirror 22 for converting a path of a laser beam B incident from the laser oscillator 10; and a hybrid pulse scanner 30 for adjusting in real time a size of an incident angle of the laser beam B, which is incident from the optic portion 20 by using (5+1) axes (X, Y, Xθ, Yθ, Z+Z-WD), while motion-controlling an irradiation angle of the adjusted laser beam B in 5-axis (X, Y, Xθ, Yθ, Z) directions, aging a location where a microhole H2 is to be processed, processing a preliminary microhole H1 at the aged location, boring the processed preliminary microhole H1, and deburring an inner surface of the bored microhole H2.

Before the description, a feature of the laser irradiation device 100 of the present invention lies in that, by allowing the incident angle of an laser beam B to be controlled in real time while the laser beam B emitted using single dedicated equipment is simultaneously motion-controlled in 5-axis directions, an initial hole aspect ratio equal to or greater than 1:10 may be achieved during processing of the microhole H2, and simultaneously, the surface roughness around the processed hole is improved, and both processing and deburring may be implemented through a single process.

In addition, it is, of course, that each driving of the laser oscillator 10, the optic portion 20, the hybrid pulse scanner 30, and the like of the laser irradiation device 100, and motion of the laser beam B, are controlled by a controller that is not illustrated.

The laser irradiation device 100 is to process super-microholes H2 ranging from thousands to hundreds of thousands for adsorption and separation of sheets on a surface of a vacuum plate P that adsorbs and laminates thin-film ceramic sheets, thin-film metal sheets, thin-film coating films, and the like for manufacturing MLCCs.

The laser oscillator 10, as illustrated in FIG. 1, is for simultaneously or selectively emitting two lasers (nanosecond laser and femtosecond laser) toward a target (microhole H2) of a vacuum plate P, and inside thereof, a femtosecond laser 11 and a nanosecond laser 12 are respectively disposed.

At this time, in the present embodiment, the femtosecond laser 11 preferably has a pulse length range of 100 fs to 10,000 fs (10 ps) so as to minimize thermal deformation and cause physical detachment on a surface of the aged target of the vacuum plate P, and the nanosecond laser 12 preferably has a pulse length range of 1 ns to 200 ns so as to raise or lower the energy concentration degree according to adjustment of the incident angle of a laser beam B that is emitted in a microhole H2 processing process described later, thereby aging a location where the microhole H2 is to be processed or melting a microhole H2 being processed by a melting pool method.

Therefore, the laser oscillator 10 is to adjust in real time the incident angle of a selected femtosecond laser 11 or nanosecond laser 12 beam according to stages of aging, boring, and deburring during microhole H2 processing in a vacuum plate P.

The optic portion 20 converts a path of the laser beam B that is selected and incident from the laser oscillator 10, so that the laser beam B may be converted in direction toward the hybrid pulse scanner 30 described later.

As illustrated in FIG. 1, the optic portion 20 may include at least two mirrors, namely a first reflection mirror 21 and a second reflection mirror 22 therein, and the incident laser beam B is converted in direction at a right angle through the first reflection mirror 21 and the second reflection mirror 22, and then emitted toward the hybrid pulse scanner 30 described later.

Here, the first reflection mirror 21 and the second reflection mirror 22 are respectively disposed at locations for reflecting beams of the femtosecond laser 11 and the nanosecond laser 12.

At this time, the second reflection mirror 22, which emits a laser beam B toward a hybrid pulse scanner 30 in the drawing, is preferably a combine mirror so that simultaneous emission or selective emission of a femtosecond laser 11 and a nanosecond laser 12 may be achieved.

The combine mirror is to allow transmission and reflection of a laser beam B to occur simultaneously, and transmits the laser beam B by coating one surface with metal having a thickness of one-half of the wavelength of the laser beam B, and reflects the laser beam B by coating the other surface with metal having a thickness of one-fourth of the wavelength of the laser beam B.

Therefore, as illustrated in the drawing, a femtosecond laser 11 is reflected through a first reflection mirror 21 and reflected by a second reflection mirror 22 to be emitted toward a hybrid pulse scanner 30, and a nanosecond laser 12 is transmitted through the second reflection mirror 22 to be emitted toward the hybrid pulse scanner 30.

That is, the optic portion 20 is to be capable of simultaneously or selectively emitting a femtosecond laser 11 and a nanosecond laser 12.

In the present embodiment, although it is illustrated that beams of a femtosecond laser 11 and a nanosecond laser 12 are emitted through a second reflection mirror 22, it is of course that a location of the second reflection mirror 22 may be changed depending on an emission location of a beam.

The hybrid pulse scanner 30 is to emit a laser beam B, which is incident from an optic portion 20, toward a vacuum plate P for processing microholes H2, and to adjust in real time a size of an incident angle (spot) of the incident laser beam B by using (5+1) axes (X, Y, Xθ, Yθ, Z+Z-WD), and to motion-control an irradiation angle of an adjusted laser beam B in 5-axis (X-axis, Y-axis, Xθ-axis, Yθ-axis, Z-axis) directions, thereby improving processing precision and processing microholes H2 in which roundness and cylindricity are secured.

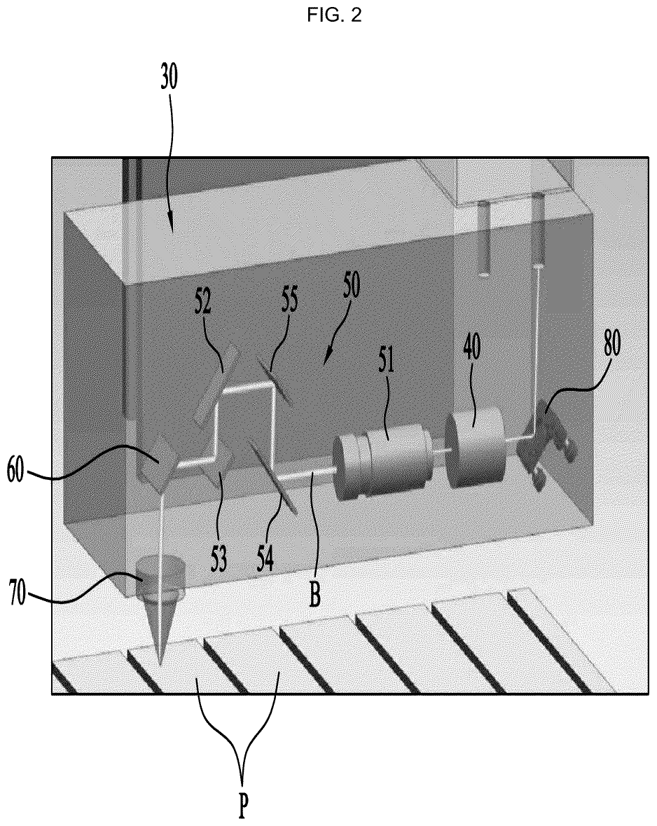

As illustrated in FIG. 2, a hybrid pulse scanner 30 may be configured to include: an incident angle adjustment module 40, which, as Z-WD (Z-Working Distance), adjusts a size of an incident angle (spot) by adjusting a diameter of a laser beam B incident from an optic portion 20 to widen or narrow a working distance of the laser beam B; a galvanometer scanner 50 including, as five axes, a focusing module 51, which is disposed on the same line as the incident angle adjustment module 40 and moves, in a Z-axis direction, a location of an incident angle (spot) of a laser beam B whose incident angle is adjusted by the incident angle adjustment module 40, an X-axis galvanometer 52, a Y-axis galvanometer 53, an Xθ-axis galvanometer 54, and a Yθ-axis galvanometer 55, through which a laser beam B passing through the focusing module 51 may be selectively emitted in 2D or 3D shapes; a beam reflector 60 for reflecting, in a Z-axis direction, a laser beam B passing through the galvanometer scanner 50; and a lens 70 disposed below the beam reflector 60 for focusing an incident angle of a reflected laser beam B to a location where a microhole H2 is processed.

In addition, at one side of the incident angle adjustment module 40, a folding mirror 80 is provided to convert a path of the laser beam B incident from the optic portion 20 so that it is directed toward the incident angle adjustment module 40.

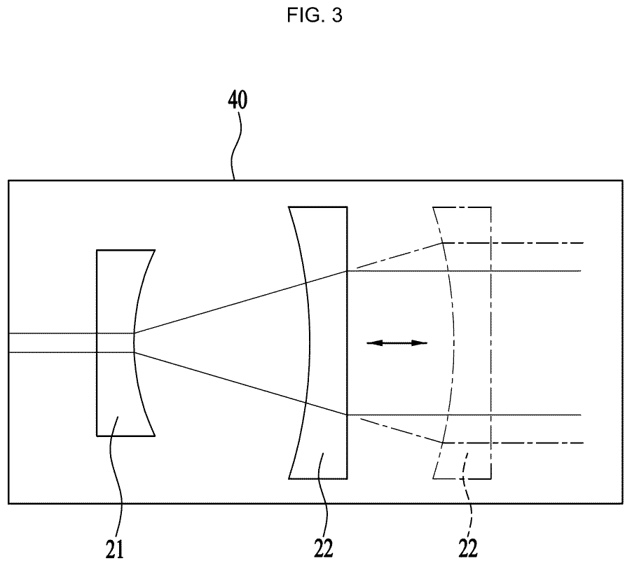

As illustrated in FIG. 3, the incident angle adjustment module 40, as the Z-WD (Z-Working Distance) axis, adjusts in real time a size of an incident angle of the beam through spacing adjustment of a pair of concave lenses 41 and 42 having different sizes.

That is, one of or each of the concave lenses 41 and 42 moves until a set incident angle of the laser beam B is formed, thereby adjusting a diameter of the laser beam B.

Such an incident angle adjustment module 40, during processing of a preliminary microhole H1, which is earlier processed for processing microholes H2, widens a diameter of the femtosecond laser 11 beam to narrow an incident angle (spot) and narrows a working distance of the laser beam B, so that a focused processing may be performed, and during boring of the microhole H2 in the preliminary microhole H1, narrows a diameter of the nanosecond laser 12 beam to widen an incident angle directed toward the Z-axis direction, thereby widening a working distance of the laser beam B and allowing a melting pool method to melt a processing area, thus controlling a size of an incident angle of each laser beam B.

In addition, during deburring of an inner surface of the bored microhole H2, when the incident angle of the nanosecond laser 12 beam is focused on the inner surface by the 5-axis motion control, the incident angle of the nanosecond laser 12 beam is widened to expand the processing area, thereby removing burrs together with improving surface roughness of the inner surface of the hole.

As a reference, since adjustment of an incident angle of a laser beam B causes the incident angle to become wider as a diameter of the laser beam B becomes smaller, an energy concentration region becomes larger, and thus focusing degree becomes lower; conversely, as the diameter of the laser beam B becomes larger, the incident angle becomes narrower, and since the energy concentration region becomes smaller, the focusing degree becomes higher.

Accordingly, in order to enhance processability of the microhole H2, the diameter of the beam should be large, whereas, for smooth processing of the inner surface of the hole, the diameter of the beam should be small.

As illustrated in FIG. 2, the galvanometer scanner 50, as five axes, allows a laser beam B emitted for processing the microhole H2 to be motion-controlled in 5-axis directions while passing through a focusing module 51, an X-axis galvanometer 52, a Y-axis galvanometer 53, an Xθ-axis galvanometer 54, and a Yθ-axis galvanometer 55, so that the beam may be emitted in a 2D shape (spiral), in a 3D shape (helical), and along X and Ye axes.

Here, since each axis galvanometer is a technology generally applied in the optical field, a detailed description thereof will be omitted.

The hybrid pulse scanner 30 as described above, through the (5+1) axes, during processing of the microhole H2 in the vacuum plate P, ages a location where the microhole H2 is to be processed to a predetermined temperature, processes a preliminary microhole H1 at the aged location, bores the processed preliminary microhole H1 to form the microhole H2, and deburrs an inner surface of the bored microhole H2, while real-time adjusting, through the incident angle adjustment module 40, an incident angle of each laser beam B being emitted.

The location where the microhole H2 is to be processed is aged by emitting the nanosecond laser 12 beam.

Further, the preliminary microhole H1 is processed at the aged location by selectively emitting the femtosecond laser 11 beam in a 2D shape and in a 3D shape.

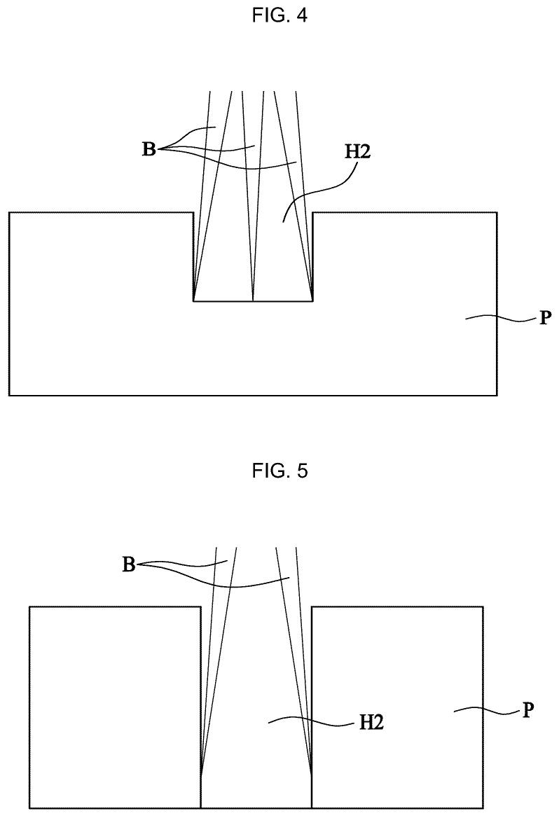

Further, the processed preliminary microhole H1 is bored to form a microhole H2 having a set depth by selectively emitting the nanosecond laser 12 beam in a 2D shape and in a 3D shape, while controlling an irradiation angle of the nanosecond laser 12 beam through (5+1)-axis motion control. At this time, the irradiation angle of the nanosecond laser 12 beam being emitted is controlled according to a depth of the microhole H2, and as illustrated in FIG. 4, this is to control the irradiation angle so that the laser beam B for processing the microhole H2 does not interfere with an entrance of the microhole H2, thereby allowing the inner surface of the microhole H2 to be processed vertically.

If it is desired to bore the microhole H2 more deeply, this may be accomplished by further adjusting the diameter of the laser beam B to be smaller; in this case, since countless diffused reflections of the laser beam B occur inside the hole being processed as the aspect ratio of the microhole H2 becomes larger, an effect of shortening processing time is also obtained.

Meanwhile, the femtosecond laser 11 and the nanosecond laser 12 emitted for processing the preliminary microhole H1 and boring the microhole H2, respectively, are in a 2D-shaped spiral form and a 3D-shaped helical form through X, Y motion combination control or X, Y, Z motion combination control among the five axes of the hybrid pulse scanner 30, and specifically, are achieved through a motion combination of the X-axis galvanometer 52 and the Y-axis galvanometer 53 of the galvanometer scanner 50 and the focusing module 51, which moves an incident angle location of the laser beam B in a Z-axis direction.

Then, the inner surface of the bored microhole H2 is deburred while emitting the nanosecond laser 12 beam along the inner surface of the microhole H2, which has been processed in a 3D-shaped form, through the (5+1)-axis motion control of the hybrid pulse scanner 30, while controlling an irradiation angle of the nanosecond laser 12 beam.

At this time, as previously described, the nanosecond laser 12 being emitted is emitted in a 3D-shaped helical form through a motion combination of (5+1) axes of the X-axis galvanometer 52, the Y-axis galvanometer 53 and the focusing module 51, which moves an incident angle location of the laser beam B in a Z-axis direction, and the irradiation angle is an angle having an inclination such that only the incident angle (spot) of the laser beam B is focused on the inner surface of the microhole H2, as illustrated in FIG. 5.

Meanwhile, during processing of the microhole H2, an irradiation angle of a laser beam B that is controlled during boring and deburring is controlled to tilt an axis of the laser beam B so that only the incident angle of the emitted laser beam B may be focused on the inner surface of the microhole H2.

Hereinafter, with reference to the accompanying drawings, a process of processing the microhole H2 in the vacuum plate P by using a laser irradiation device 100 having with the hybrid pulse scanner 30 according to the present invention will be described as follows.

A method for processing the microhole H2 by using the laser irradiation device 100 includes: step S10 of aging, by simultaneously or selectively emitting nanosecond laser 12 and femtosecond laser 11 to a location where the microhole H2 of the vacuum plate P is to be processed; step S20 of processing a preliminary microhole H1 while emitting a femtosecond laser 11 beam in a 2D shape and in a 3D shape to the aged location; step S30 of boring the microhole H2 while selectively emitting a nanosecond laser 12 beam in a 2D shape and in a 3D shape while controlling an irradiation angle of the nanosecond laser 12 beam through (5+1)-axis (X, Y, Xθ, Yθ, Z+Z-WD) motion control, into the processed preliminary microhole H1; and step S40 of deburring an inner surface while emitting the nanosecond laser 12 beam along the inner surface of the microhole H2 in a 3D shape through the (5+1)-axis (X, Y, Xθ, Yθ, Z+Z-WD) motion control.

First, the vacuum plate P to be processed is seated on a stage that is not illustrated.

This stage may move in X-axis and Y-axis directions.

Then, the hybrid pulse scanner 30 is lowered by a height set above the upper mold.

Step S10 of aging, by simultaneously or selectively emitting the nanosecond laser 12 and the femtosecond laser 11 to a location where the microhole H2 of the vacuum plate P is to be processed, is a step of aging the location where the microhole H2 seated on the stage is to be processed.

In this step, the nanosecond laser 12 and the femtosecond laser 11 may be simultaneously or selectively emitted, but for description, it will be explained as being simultaneously emitted.

First, the hybrid pulse scanner 30 simultaneously emits the nanosecond laser 12 and the femtosecond laser 11 toward a location where the microhole H2 of the vacuum plate P is to be processed.

At this time, the nanosecond laser 12 and the femtosecond laser 11 are emitted with different outputs.

For example, when the nanosecond laser 12 is 100 W and the femtosecond laser 11 is 100 W, and assuming that a processing threshold of the vacuum plate P is 50 W, by setting the nanosecond laser 12 to 10 W, which is lower than the processing threshold, and setting the femtosecond laser 11 to 50 W, which is at least equal to the processing threshold, among the simultaneously emitted laser beams B, the nanosecond laser 12 ages a location where the microhole H2 is to be processed, and simultaneously, the femtosecond laser 11, which will be described later, heats the aged location so that the microhole H2 may be allowed to be processed.

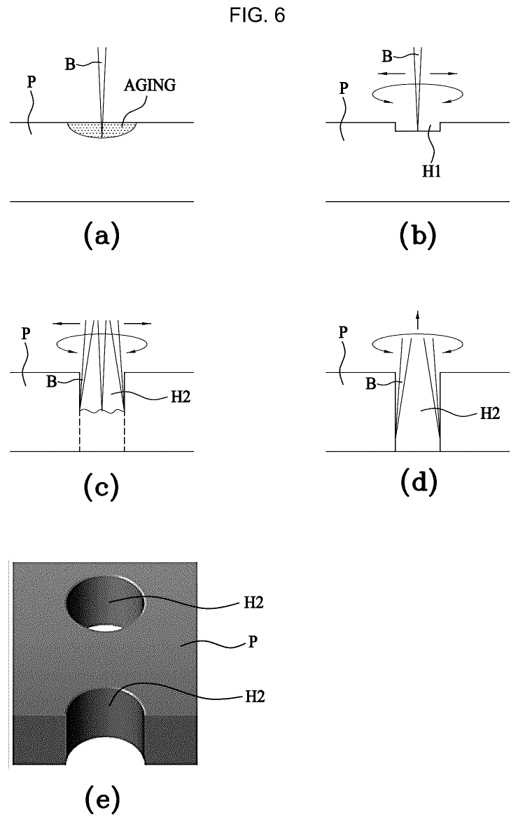

Meanwhile, as illustrated in FIG. 6(a), an incident angle of the nanosecond laser 12 beam being emitted is located at a set depth inside the vacuum plate P, and since it is emitted at an output lower than the processing threshold, a hole is not processed, but the processing location is aged.

At this time, it is preferable that an aging temperature of the vacuum plate P, which is a metallic material, is aged to 80 °C or higher, which is higher than room temperature (around 20 °C). This is because, by processing the aged location using the femtosecond laser 11 described later, fragmental particles around the processed microhole H2 are prevented from being generated by reducing thermal effects, thereby improving quality of roundness and cylindricity.

If processing using the nanosecond laser 12 is to be performed, energy concentration degree may be increased so that energy per unit area may reach the threshold. In such a case, processing by melting using heat from the nanosecond laser 12 becomes possible.

However, since the purpose of the present step is aging, the threshold is set low.

Step S20 of processing a preliminary microhole H1 while emitting a femtosecond laser 11 beam in a 2D shape and in a 3D shape to the aged location is a step of processing the preliminary microhole H1 at a set depth on the aged processing location in order to bore the microhole H2.

The femtosecond laser 11, which is simultaneously emitted with the nanosecond laser 12, is alternately emitted to the aged location in 2D-shaped spiral form and 3D-shaped helical form through a motion combination of the X-axis galvanometer 52, the Y-axis galvanometer 53, and the focusing module 51, and processes the preliminary microhole H1 having a set depth, and such a depth is not limited, as long as molten material does not overflow during boring of the microhole H2 described later.

At this time, the nanosecond laser 12 may maintain a continuous emission state so that processing of the preliminary microhole H1 by the femtosecond laser 11 may be stably performed.

Here, the femtosecond laser 11 causes physical detachment of the aged processing location to process the preliminary microhole H1, as illustrated in FIG. 6(b), and in order to minimize thermal deformation of a surface of the processing location, it has a pulse length of 100 fs to 10,000 fs (10 ps), and a femtosecond laser 11 having a range of 700 fs to 800 fs is used.

In addition, the femtosecond laser 11 is repeatedly emitted in a 2D-shaped spiral form and a 3D-shaped helical form, respectively through motion combination control of the X-axis galvanometer 52 and the Y-axis galvanometer 53, or motion combination control of the X-axis galvanometer 52, the Y-axis galvanometer 53, and the focusing module 51, as indicated by an arrow direction in FIG. 6(b) among the five axes of the hybrid pulse scanner 30.

In addition, the femtosecond laser 11 being emitted has a narrowed working distance of the beam, and since it is emitted with a widened beam diameter so that the incident angle becomes narrowed by the incident angle adjustment module 40, focused processing is achieved, and melt protrusions, fragmental particles, burrs, and the like are not formed around the processed preliminary microhole H1, thereby allowing clear processing without the need for a post-process.

Step S30 of boring the microhole H2 while selectively emitting a nanosecond laser 12 beam in a 2D shape and in a 3D shape, together with controlling an irradiation angle of the nanosecond laser 12 beam through (5+1)-axis (X, Y, Xθ, Yθ, Z+Z-WD) motion control to the processed preliminary microhole H1, is a step of processing the microhole H2 in the preliminary microhole H1.

First, the femtosecond laser 11 is blocked simultaneously with the processing of the preliminary microhole H1, and an output of the nanosecond laser 12 is set higher than the processing threshold to increase energy concentration degree per unit area, and is emitted toward the preliminary microhole H1.

As illustrated in FIG. 6(c), as the interior of the preliminary microhole H1 is melted while the nanosecond laser 12 emits toward the preliminary microhole H1, the nanosecond laser 12 bores the preliminary microhole H1 downward in a direction indicated by a dotted line in FIG. 6(c) by a melting pool method, thereby forming the microhole H2.

At this time, the nanosecond laser 12 is alternately emitted in a 2D-shaped spiral form and a 3D-shaped helical form through a motion combination of the X-axis galvanometer 52, Y-axis galvanometer 53, Xθ-axis galvanometer 54, Yθ-axis galvanometer 55, and the focusing module 51, which are five axes, and the incident angle adjustment module 40, as a +1 axis, thereby gradually moving the incident angle in the Z-axis direction in the drawing.

Simultaneously, when the nanosecond laser 12 is emitted and moved in the Z-axis direction by the focusing module 51, the incident angle adjustment module 40 reduces a diameter of the nanosecond laser 12 beam in real time, so that the emitted beam does not interfere with an entrance of the microhole H2, and the five axes control in real time an irradiation angle of the nanosecond laser 12, whose beam diameter has been narrowed (see FIG. 4).

Specifically, with the (5+1) axes, through the focusing module 51, the X-axis galvanometer 52, the Y-axis galvanometer 53, the Xθ-axis galvanometer 54, and the Yθ-axis galvanometer 55, the irradiation angle of the nanosecond laser 12 beam is controlled, and through the incident angle adjustment module 40, a working distance of the incident angle of the nanosecond laser 12 beam is widened, so that the preliminary microhole H1 may be bored by a melting pool method that melts a processing area, by narrowing in real time the beam diameter of the nanosecond laser 12.

In addition, as the beam diameter adjustment and irradiation angle control of the nanosecond laser 12 beam are performed through the (5+1) axes, the inner surface of the bored microhole H2 may be processed vertically, as illustrated in FIG. 4.

Simultaneously, the nanosecond laser 12 is repeatedly emitted in a 2D-shaped spiral form and a 3D-shaped helical form, respectively, through motion combination control of the X-axis galvanometer 52 and the Y-axis galvanometer 53, or through motion combination control of the X-axis galvanometer 52, the Y-axis galvanometer 53, and the focusing module 51, as indicated by an arrow direction in FIG. 6(c) among the five axes of the hybrid pulse scanner 30.

At this time, it is preferable that a pulse length of the nanosecond laser 12 beam emitted for boring the microhole H2 is in a range of 1 ns to 200 ns.

Step S40 of deburring, while emitting the nanosecond laser 12 beam along the inner surface of the microhole H2 in a 3D-shaped form through the (5+1)-axis (X, Y, Xθ, Yθ, Z+Z-WD) motion control, is a step of completing the microhole H2 processing through deburring.

First, as illustrated in FIG. 5, an irradiation angle of the nanosecond laser 12, which bored the microhole H2, is tilted at a predetermined angle through the motion control by driving the focusing module 51, the X-axis galvanometer 52, the Y-axis galvanometer 53, the Xθ-axis galvanometer 54, and the Ye-axis galvanometer 55 of the five axes.

Simultaneously, the nanosecond laser 12, under control of the incident angle adjustment module 40, as a Z-WD axis, among the (5+1) axes, narrows a diameter of the nanosecond laser 12 beam to widen an incident angle (spot).

As a result, since the nanosecond laser 12 is in a tilted state, only the widened incident angle of the nanosecond laser 12 is focused on the inner surface of the microhole H2, as illustrated in FIG. 5, and in this state, the nanosecond laser 12, through the 5-axis motion control, moves in a Z-axis direction along the inner surface of the microhole H2 in a 3D-shaped helical form, as indicated by an arrow illustrated in FIG. 6(d), thereby deburring the inner surface.

The deburring is performed up to an entrance of the microhole H2, and when it is completed, as illustrated in FIG. 6(e), processing of the microhole H2 is completed with high-quality roundness and cylindricity ensured.

At this time, it is preferable that a pulse length of the nanosecond laser 12 beam emitted for deburring is in the same range of 1 ns to 200 ns as in step S30.

After processing of the microhole H2 is completed, the stage on which the vacuum plate P is seated is moved for processing the next microhole H2, and while repeatedly performing the above-described method, a plurality of microholes H2 are processed.

As described above, according to the laser irradiation device having a hybrid pulse scanner and a method for processing microholes in a vacuum plate by using the same of the present invention, while simultaneously or selectively emitting the femtosecond laser and the nanosecond laser through single dedicated equipment, and allowing a beam incident angle (spot) to be real-time controlled, together with motion control of the laser beam in 5-axis directions, a microhole aspect ratio may be processed deeper than 1:10, and since deburring may be immediately performed after microhole boring, a microhole having precise and high-quality roundness and cylindricity is processed in the vacuum plate, thereby exhibiting an excellent effect of improving quality of the vacuum plate.

In addition, since the femtosecond laser beam is emitted to process a preliminary microhole for processing the microhole, there is an effect that burrs are not formed around the hole.

In addition, since the processing part is aged in the single dedicated equipment, and the femtosecond laser beam and the nanosecond laser beam are sequentially and continuously emitted to form and bore the preliminary microhole, and immediate deburring of the bored inner surface is continuously performed, there is an effect not only that the processing time is shortened, but also that, above all, a separate post-process for burr removal and deburring, as in the conventional method, is not required.

1. A laser irradiation device (100) having a hybrid pulse scanner (30) for processing super-microholes (H2) in a vacuum plate (P) that adsorbs, conveys, and laminates thin-film ceramic sheets, thin-film metal sheets, thin-film coating films, and the like, the laser irradiation device (100) comprising:
a laser oscillator (10) configured to simultaneously or selectively emitting a femtosecond laser (11) beam and a nanosecond laser (12) beam;
an optic portion (20) including a first reflection mirror (21) and a second reflection mirror (22) configured to convert a path of a laser beam (B) incident from the laser oscillator (10); and
a hybrid pulse scanner (30) configured to adjust in real time a size of an incident angle of the laser beam (B) which is incident from the optic portion 20 by using (5+1) axes (X, Y, Xθ, Yθ, Z+Z-WD), while motion controlling an irradiation angle of the adjusted laser beam (B) in 5-axis (X, Y, Xθ, Yθ, Z) directions, age a location where the microhole (H2) is to be processed, process a preliminary microhole (H1) at the aged location, bore the processed preliminary microhole (H1), and deburr an inner surface of the bored microhole (H2),
wherein the hybrid pulse scanner (30) comprises:
an incident angle adjustment module (40) configured to widen or narrow a working distance (WD) by adjusting the size of the incident angle of the incident laser beam (B) as Z-Working Distance (Z-WD);
a galvanometer scanner (50) including, as five axes, a focusing module (51), the focusing module (51) moving an incident angle location of the laser beam (B) that has passed through the incident angle adjustment module (40) in a Z-axis direction, an X-axis galvanometer (52), a Y-axis galvanometer (53), an Xθ-axis galvanometer (54), and a Yθ-axis galvanometer (55), which allow the laser beam (B) passing through the focusing module (51) to be selectively emitted in 2D or 3D shapes;
a beam reflector (60) configured to reflect the laser beam (B) passed through the galvanometer scanner (50) in the Z-axis direction; and
a lens (70) disposed below the beam reflector (60) to focus an incident angle of the reflected laser beam (B) onto the location where the microhole (H2) is processed.

2. The laser irradiation device of claim 1, wherein the location where the microhole (H2) is to be processed is aged through emission of the nanosecond laser (12) beam;
at the aged location, while the femtosecond laser (11) beam is selectively emitted in a 2D shape and in a 3D shape to process the preliminary microhole (H1);
to the processed preliminary microhole (H1), the microhole (H2) is bored while selectively emitting the nanosecond laser (12) beam in a 2D shape and in a 3D shape together with controlling an irradiation angle of the nanosecond laser (12) beam through (5+1)-axis motion control; and
through the (5+1)-axis motion control, an inner surface of the processed microhole (H2) is deburred while emitting the nanosecond laser (12) beam in a 3D shape along the inner surface of the processed microhole (H2) together with controlling the irradiation angle of the nanosecond laser (12) beam.

3. The laser irradiation device of claim 2, wherein the femtosecond laser (11) and the nanosecond laser (12) emitted for processing the preliminary microhole (H1) and boring the microhole (H2) are respectively in a 2D-shaped spiral form and in a 3D-shaped helical form through X, Y motion combination control or X, Y, Z motion combination control among five axes of the hybrid pulse scanner (30).

4. The laser irradiation device of claim 2, wherein the incident angle adjustment module (40) adjusts the size of the incident angle of the laser beam (B) in real time through spacing adjustment of a pair of concave lenses (41, 42);
during processing of the preliminary microhole (H1), a diameter of the femtosecond laser (11) beam is widened to narrow the incident angle so that focused processing is performed by narrowing a working distance of the laser beam (B); and
during boring of the microhole (H2) into the preliminary microhole (H1), a diameter of the nanosecond laser (12) beam is narrowed to widen the incident angle so that a melting pool method for melting a processing area is performed by widening the working distance of the laser beam (B).

5. A method for processing microholes in a vacuum plate, using the laser irradiation device having a hybrid pulse scanner described in claim 1, the method comprising:
step S10 of aging by simultaneously or selectively emitting the nanosecond laser (12) and the femtosecond laser (11) to a location at which the microhole (H2) of the vacuum plate (P) is to be processed;
step S20 of processing the preliminary microhole (H1) while emitting the femtosecond laser (11) beam in a 2D shape and in a 3D shape to the aged location;
step S30 of boring the microhole (H2) while selectively emitting the nanosecond laser (12) beam in a 2D shape and in a 3D shape together with controlling an irradiation angle of the nanosecond laser (12) beam through (5+1)-axis (X, Y, Xθ, Yθ, Z+Z-WD) motion control to the processed preliminary microhole (H1); and
step S40 of deburring an inner surface of the microhole (H2) while emitting the nanosecond laser (12) beam in a 3D shape along the inner surface of the microhole (H2) through the (5+1)-axis (X, Y, Xθ, Yθ, Z+Z-WD) motion control,
wherein, in step S30, the diameter of the nanosecond laser (12) beam is narrowed so that a melting pool method for melting a processing area is performed by widening a working distance of an incident angle while controlling the irradiation angle of the nanosecond laser (12) beam to bore the preliminary microhole (H1).

6. The method of claim 5, wherein in step S20, the emission of the femtosecond laser (11) beam is performed in a state in which the diameter of the beam is widened to narrow an incident angle so that focused processing is performed while a working distance is narrowed.

7. The method of claim 5, wherein in step S20, a pulse length of the femtosecond laser (11) is 100 fs to 10,000 fs (10 ps).

8. The method of claim 5, wherein, in step (S40), under control of the incident angle adjustment module (40), as a Z-WD axis, the diameter of the nanosecond laser (12) beam is narrowed so as to widen the incident angle, and the irradiation angle of the beam is controlled so that only the widened incident angle is focused on an inner surface of a microhole (H2), thereby deburring the inner surface of the microhole (H2) in a 3D-shaped helical form along the inner surface of the microhole (H2).

9. The method of claim 5, wherein, in steps S30 and S40, a pulse length of the nanosecond laser (12) is 1 ns to 200 ns.

10. The method of claim 5, wherein, in steps S20 and S30, the femtosecond laser (11) and the nanosecond laser (12), which are emitted respectively, are repeatedly emitted in a 2D-shaped spiral form and in a 3D-shaped helical form, respectively, through X, Y motion combination control or X, Y, Z motion combination control among five axes of the hybrid pulse scanner (30).
